(19) United States
(12) Patent Application Publication
(10) Pub. No.: US 2021/0223825 A1
(43) Pub. Date: Jul. 22, 2021

(54) COMPUTING DEVICE MODULES

(71) Applicant: Hewlett-Packard Development Company, L.P., Spring, TX (US)

(72) Inventors: Peter Seiler, Fort Collins, CO (US); Adolfo Gomez, Fort Collins, CO (US); Aaron M. Laaveg, Fort Collins, CO (US); Paul Howard Mazurkiewicz, Fort Collins, CO (US); Alexander Wayne Clark, Spring, TX (US); Nicole Aranci, Fort Collins, CO (US); Adam Jordan Christon, Fort Collins, CO (US); Michael Leighton Nash, Clyde Hill, WA (US); Andrew Warren Willard, Fort Collins, CO (US); Barbara Palmer Pickering, Palo Alto, CA (US); Hoang Van Ngo, Spring, TX (US)

(73) Assignee: Hewlett-Packard Development Company, L.P., Spring, TX (US)

(21) Appl. No.: 16/977,858

(22) PCT Filed: Jun. 1, 2018
(86) PCT No.: PCT/US2018/035689

§ 371 Date: Sep. 3, 2020

(51) Int. Cl. G06F 1/16

(52) U.S. Cl. CPC G06F 1/1669; G06F 1/169; G06F 1/1683; G06F 1/1635

(57) ABSTRACT

In an example implementation according to aspects of the present disclosure, a method may include detecting, by a computing device, termination of a wired connection via a connector, after a module is detached from a cavity of the computing device, and automatically switching from the wired connection to a wireless connection between the module and the computing device, to maintain the data communications between the module and the computing device.

### BACKGROUND

The emergence and popularity of mobile computing has made portable computing devices, due to their compact design and light weight, a staple in today's marketplace. Within the mobile computing realm, notebook computers, or laptops, are one of the most widely used devices and generally employ a clamshell-type design having two members connected together at a common end via hinges, for example. In some cases, a first or display member is utilized to provide a viewable display to a user while a second or base member includes an area for user input (e.g., touchpad and keyboard). In addition, the viewable display may be a touchscreen (e.g., touchscreen laptop), allowing the user to interact directly with what is displayed by touching the screen with simple or multi-touch gestures.

### BRIEF DESCRIPTION OF THE DRAWINGS

FIG. 1 illustrates a computing device with modules that are attachable to the computing device, according to an example;

FIG. 2 illustrates a computing device for maintaining data communications with modules as they are attached to and detached from the computing device, according to an example; and

FIG. 3 is a flow diagram in accordance with an example of the present disclosure.

### DETAILED DESCRIPTION

Examples disclosed herein provide the ability to attach various human interface devices (HIDs) to computing devices, such as notebook computers, and maintain data communications with such HIDs even when they are detached from computing devices. As a result, if an HID is detached from a computing device, by facilitating the transition of the HID from a wired system interface to a wireless system interface, the HID may still be used as an interface to the computing device. This may be particularly useful as notebook computers begin to include features that allow the device to be “converted” from one style of use to at least another style of use. For example, a notebook computer may be converted from a laptop operating position, where the touchpad and keyboard are used as input components, to a tablet operating position, where the viewable display is used for both viewing and input. However, as an HID of the device, such as the keyboard, may still be desirable for use while in tablet operating position, having the ability to detach the keyboard from the computing device and continue to use with the computing device (e.g., via the wireless system interface), may be useful. Such devices that serve this dual purpose may be called convertible laptops.

In addition, multiple HIDs may be used to interface with the computing device simultaneously. For example, a first HID may be attached to the computing device and communicate via a wired connection, and a second HID may communicate with the computing device via a wireless connection. Examples of HIDs include, but are not limited to, keyboards, trackpads, a secondary touch display, motion capture devices, and a pad for accepting pen input. An HID module may also include a combination of HIDs.

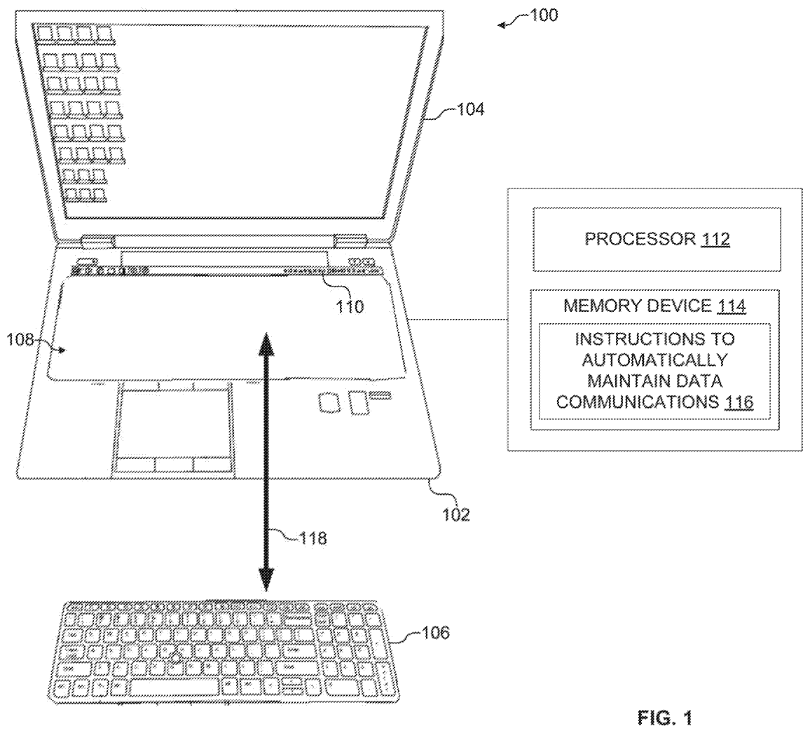

With reference to the figures, FIG. 1 illustrates a computing device 100 with modules 106 that are attachable to the computing device 100, according to an example. The module 106 may correspond to the HIDs described above. The computing device 100 includes a display member 104 and a base member 102 that are rotatably connected to each other. As an example, the base member 102 includes a cavity 108 for receiving the module 106. A connector 110 may be disposed within the cavity 108 for establishing data communications between the module 106 and the computing device 100 when the module 106 is attached to the base member 102. Placement of the connector 110 within the cavity 108 may vary, and is not limited to the location illustrated. For example, as the module 106 may be flipped over when inserted within the cavity 108, as will be further described, the connector 110 may be located within a middle region of the cavity 108, to accommodate either side of the module 106. The display member 104 includes a display surface that may be used for viewing the video output of the computing device 100, and include input means for operation by a user, such as a touchscreen.

The computing device 100 depicts a processor 112 and a memory device 114 and, as an example of the computing device 100 performing its operations, the memory device 114 may include instruction 116 that is executable by the processor 112. Thus, memory device 114 can be said to store program instructions that, when executed by processor 112, implement the components of the computing device 100. The executable program instructions stored in the memory device 114 include, as an example, instructions to automatically maintain data communications (116).

Instructions to automatically maintain data communications (116) represent program instructions that when executed by the processor 112 cause the computing device 100 to detect when the module 106 is detached from the base member 102, in order to automatically maintain the data communications between the module 106 and the computing device 100. As an example, when the module 106 is attached within the cavity 108 of the base member 102, the connector 110 provides a wired connection to establish the data communication between the module 106 and the computing device 100. As a result, in order to maintain the data communications when the module 106 is detached from the base member 102, the processor 112 may automatically switch from the wired connection, for example, provided by the connector 110, to a wireless connection between the module 106 and the computing device 100. As an example, the computing device 100 and module 106 may each include a transceiver for maintaining the data communications via a wireless connection. Technologies for enabling the wireless connection include, but are not limited to, Bluetooth, Wi-Fi, and Wi-Gig. By switching seamlessly from the wired to wireless connection, data communications between the module 106 and computing device 100 is maintained. As an example, a battery internal to the module 106 may be enabled or disabled, based on whether the module 106 is detached from the computing device 100, in order for the module 106 to remain powered when it wirelessly connected to the computing device 100.

As illustrated in FIG. 1, the module 106 may be either attached to or detached from the cavity 108 of the base member 102 of the computing device 100, as indicated by arrow 118. As an example, when the module 106 is reattached to the base member 102 via the connector 110, the processor 112 may automatically switch from the wireless connection back to the wired connection between the module 106 and the computing device 100. Wired connections may be preferable when available, for example, for security reasons. When the module 106 is reattached to the base member 102, rather than continuing to power itself, the module 106 may be powered by the computing device 100. As a result, the processor 112 may disable the transceiver and battery internal to the module 106. As an example, the processor 112 may also engage a charging circuit to maintain charge in the battery internal to the module 106, in order for the module 106 to be fully powered when it is later detached from the computing device 100.

Having the capability to detach the module 106 from the computing device 100 allows for various HIDs to be attached to the computing device 100. As an example, a first side of the module 106 may correspond to a first type of user input (e.g., keyboard), and a second side of the module 106 may correspond to a second type of user input (e.g., pad for accepting pen input). Based on the detected direction the module 106 is attached to the base member 102, the processor 112 may enable either the first or second side as a form of input for the computing device 100. As an example, a sensor, such as an accelerometer, may be used to determine whether the first or second side is facing up. However, various techniques may be used for determining which side of the module 106 is facing up.

As an example, rather than having various types of user input on either side of the module 106, only one side of the module 106 may include a form of input (e.g., the first side). The module 106 may then be flipped over to the other side, for example, when it is desirable to protect the input device on the first side of the module 106. As an example of a convertible laptop described above, hinges coupling the base and display members 102, 104 may allow the display member 104 to flip 360 degrees when transitioning from laptop mode to tablet mode. As a result of flipping over the display member 104 by 360 degrees, the display member 104 and base member 102 may be collapsed against each other in an open, folded position, then exposing the module 106. In order to protect, for example, a keyboard on a first side of the module 106, the module 106 may be flipped over to avoid damage to the keyboard, when the module 106 is exposed.

In addition, as mentioned above, multiple modules may be used to interface with the computing device 100 simultaneously. For example, the first module 106 may be detached from the computing device 100 and communicate via a wireless connection, and a second module (not shown) may be attached within the cavity 108 of the base member 102 and communicate with the computing device 100 via a wireless connection. The processor 112 may then process input received from the first and second modules. For example, the input from the first module 106 is received via the wireless connection and the input from the second module is received via a wired connection via the connector 110.

Memory device 114 represents generally any number of memory components capable of storing instructions that can be executed by processor 112. Memory device 114 is non-transitory in the sense that it does not encompass a transitory signal but instead is made up of at least one memory component configured to store the relevant instructions. As a result, the memory device 114 may be a non-transitory computer-readable storage medium. Memory device 114 may be implemented in a single device or distributed across devices. Likewise, processor 112 represents any number of processors capable of executing instructions stored by memory device 114. Processor 112 may be integrated in a single device or distributed across devices. Further, memory device 114 may be fully or partially integrated in the same device as processor 112, or it may be separate but accessible to that device and processor 112.

In one example, the program instruction 116 can be part of an installation package that when installed can be executed by processor 112 to implement the components of the computing device 100. In this case, memory device 114 may be a portable medium such as a CD, DVD, or flash drive or a memory maintained by a server from which the installation package can be downloaded and installed. In another example, the program instructions may be part of an application or applications already installed. Here, memory device 114 can include integrated memory such as a hard drive, solid state drive, or the like.

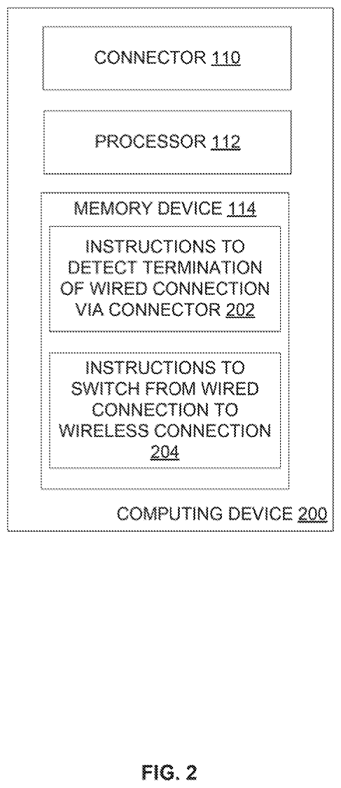

FIG. 2 illustrates a computing device 200 for maintaining data communications with modules as they are attached to and detached from the computing device 200, according to an example. Examples of the computing device 200 include, but are not limited to, notebook computers. As illustrated, the computing device 200 includes connector 110 for providing a wired connection between the modules and the computing device 200, in order to establish data communications, as described above. Using similar reference numerals from FIG. 1, the computing device 200 depicts a processor 112 and a memory device 114 and, as an example of the computing device 200 performing its operations, the memory device 114 may include instructions 108-110 that are executable by the processor 112. The executable program instructions stored in the memory device 114 include, as an example, instructions to detect termination of the wired connection via connector 110 (202), and instructions to switch from wired connection to wireless connection (204).

Instructions to detect termination of the wired connection via connector 110 (202) represent program instructions that when executed by the processor 112 cause the computing device 200 to detect when a module is detached from a cavity of the computing device 200 (e.g., cavity 108 of computing device 100 in FIG. 1). As an example, detection may occur when the wired connection via the connector 110 is terminated, upon detachment of the module.

Instructions to switch from wired connection to wireless connection (204) represent program instructions that when executed by the processor 112 cause the computing device 200 to automatically switch to the appropriate connection, for example, in order to maintain the data communications between the module and the computing device 200. As described above, the computing device 200 and module may each include a transceiver for maintaining the data communications via a wireless connection. In addition, a battery internal to the module may be enabled, for example, when the module is detached from the computing device 200, in order for the module to remain powered when it wirelessly connected to the computing device 200.

As an example, when the module is reattached within the cavity of the computing device 200, to the connector 110, the processor 112 may automatically switch from the wireless connection back to the wired connection between the module and the computing device 200. In addition, rather than continuing to power itself, the module may be powered by the computing device 100. As a result, the processor 112 may disable the transceiver and battery internal to the module. As an example, the processor 112 may also engage a charging circuit to maintain charge in the battery internal to the module, in order for the module to be fully powered when it is later detached from the computing device 200.

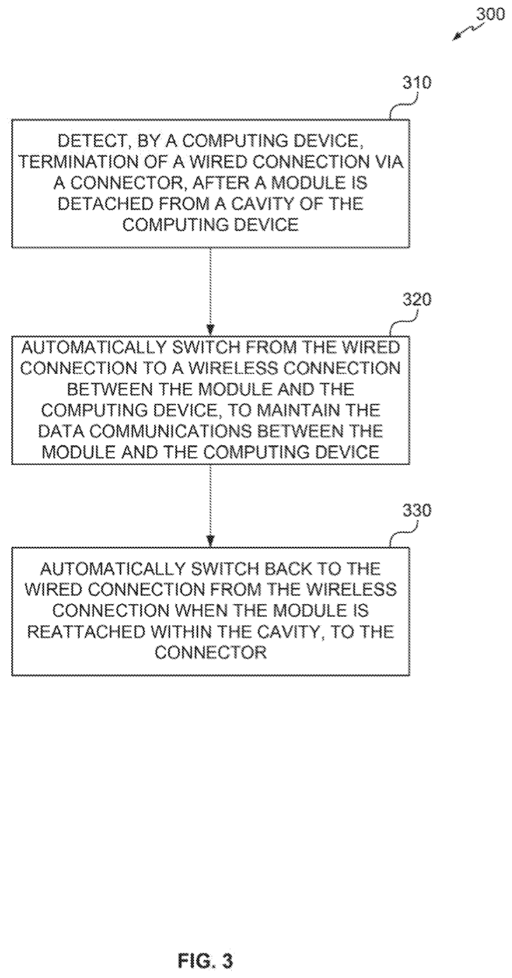

FIG. 3 is a flow diagram 300 of steps taken by a computing device to maintain data communications with modules as they are attached to and detached from the computing device, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

At 310, the computing device detects termination of a wired connection via a connector, after a module is detached from a cavity of the computing device. Referring back to computing device 100 of FIG. 1, a connector 110 may be disposed within the cavity 108 for establishing data communications between the module 106 and the computing device 100 when the module 106 is attached to the base member 102. As an example, when the module 106 is attached within the cavity 108 of the base member 102, the connector 110 provides a wired connection to establish the data communication between the module 106 and the computing device 100.

At 320, the computing device automatically switches from the wired connection to a wireless connection between the module and the computing device, to maintain the data communications between the module and the computing device. As an example, the computing device and module may each include a transceiver for maintaining the data communications via a wireless connection. Technologies for enabling the wireless connection include, but are not limited to, Bluetooth, Wi-Fi, and Wi-Gig. By switching seamlessly from the wired to wireless connection, data communications between the module and computing device is maintained. As an example, a battery internal to the module may be enabled or disabled, based on whether the module is detached from the computing device, in order for the module to remain powered when it wirelessly connected to the computing device.

At 330, the computing device automatically switches back to the wired connection from the wireless connection when the module is reattached within the cavity, to the connector. When the module is reattached within the cavity, rather than continuing to power itself, the module may be powered by the computing device. As a result, the transceiver and battery internal to the module may be disabled. As an example, the computing device may also charge the battery internal to the module, in order for the module to be fully powered when it is later detached from the computing device.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A computing device comprising:
a base member;
a display member rotatably connected to the base member;
a first module to interface with the computing device, wherein the first module is receivable within a cavity of the base member;
a connector to establish data communications between the first module and the computing device when the first module is attached to the base member; and
a processor to:
automatically maintain the data communications between the first module and the computing device after the first module is detached from the base member.

2. The computing device of claim 1, wherein the processor to automatically maintain the data communications comprises the processor to:
detect termination of a wired connection via the connector, after the first module is detached from the base member; and
automatically switch from the wired connection to a wireless connection between the first module and the computing device, to maintain the data communications between the first module and the computing device.

3. The computing device of claim 2, wherein the processor is to automatically switch back to the wired connection from the wireless connection when the first module is reattached to the base member via the connector.

4. The computing device of claim 3, wherein when the first module is reattached to the base member, the processor is to:
disable a battery associated with the first module; and
engage a charging circuit to maintain charge in the battery.

5. The computing device of claim 2, comprising:
a second module to interface with the computing device, wherein the second module is receivable within the cavity of the base member via the connector, to establish data communications between the second module and the computing device when the second module is attached to the base member.

6. The computing device of claim 5, wherein the processor is to process input received from the first and second modules, wherein the input from the first module is received via the wireless connection and the input from the second module is received via a wired connection via the connector.

7. The computing device of claim 1, wherein the first module comprises a first side and a second side opposite to the first side, and the processor is to:
detect a direction the first module is attached to the base member; and
based on the direction, enable either the first side or the second side as a form of input for the computing device.

8. A non-transitory computer-readable storage medium comprising program instructions which, when executed by a processor of a computing device, cause the processor to:
detect termination of a wired connection to a first module via a connector, after the first module is detached from a cavity of the computing device; and
automatically switch from the wired connection to a wireless connection between the first module and the computing device, to maintain data communications between the first module and the computing device.

9. The non-transitory computer-readable storage medium of claim 8, wherein, when executed, the instructions further cause the processor to automatically switch back to the wired connection from the wireless connection when the first module is reattached within the cavity, to the connector.

10. The non-transitory computer-readable storage medium of claim 9, wherein, when executed, when the first module is reattached within the cavity, the instructions further cause the processor to:
disable a battery associated with the first module; and
engage a charging circuit to maintain charge in the battery.

11. The non-transitory computer-readable storage medium of claim 8, wherein the first module comprises a first side and a second side opposite to the first side, and, when executed, the instructions further cause the processor to:
detect a direction the first module is attached within the cavity; and
based on the direction, enable either the first side or the second side as a form of input for the computing device.

12. The non-transitory computer-readable storage medium of claim 8, comprising:
a second module to interface with the computing device, wherein the second module is receivable within the cavity, to establish data communications between the second module and the computing device when the second module is attached within the cavity, to the connector.

13. The non-transitory computer-readable storage medium of claim 12, wherein, when executed, the instructions further cause the processor to process input received from the first and second modules, wherein the input from the first module is received via the wireless connection and the input from the second module is received via a wired connection via the connector.

14. A method comprising:
detecting, by a computing device, termination of a wired connection to a module via a connector, after the module is detached from a cavity of the computing device;
automatically switching from the wired connection to a wireless connection between the module and the computing device, to maintain data communications between the module and the computing device; and
automatically switching back to the wired connection from the wireless connection when the module is reattached within the cavity, to the connector.

15. The method of claim 14, wherein the module comprises a first side and a second side opposite to the first side, and the processor is to:
detect a direction the first module is attached to the base member; and
based on the direction, enable either the first side or the second side as a form of input for the computing device.
